(19) United States
(12) Patent Application Publication
(10) Pub. No.: US 2019/0106230 A1
(43) Pub. Date: Apr. 11, 2019

(54) MACHINE FOR PACKAGING PIECE GOOD COMBINATIONS WITH ADDITIONAL DECORATING DEVICE

(71) Applicant: KRONES AG, Neutraubling (DE)

(72) Inventor: Helmut Schwarz, Strasslach-Dingharting (DE)

(21) Appl. No.: 16/086,890

(22) PCT Filed: Dec. 29, 2016
(86) PCT No.: PCT/EP2016/082838

§ 371 Date: Sep. 20, 2018

(30) Foreign Application Priority Data
Apr. 12, 2016 (DE) 10 2016 106 731.8

(51) Int. Cl. B65B 11/00; B65B 11/58; B65B 59/02; B65B 61/06; B65B 61/26; B65C 1/00; B41J 3/407

(52) U.S. Cl. CPC B65B 11/008; B65B 11/58; B65B 59/02; B65B 2210/04; B65B 61/26; B65C 1/00; B41J 3/4073; B65B 61/06

(57) ABSTRACT

Machine for packaging piece good combinations with a transport device which transports a plurality of piece goods in a predetermined transport direction, with a first wrapping device which is suitable and intended for wrapping the piece goods with a film element, wherein this first wrapping device has a dispensing unit revolving around the piece goods, wherein the piece goods can be delivered to the first wrapping device in order be wrapped by the film element, and with at least one separating device arranged downstream of the first wrapping device in the transport direction of the piece goods, which separates portions of the stream of piece goods wrapped with the first film element from one another and/or promotes a separating process. According to the invention the machine has a decorating device which provides the piece goods with at least one decoration.

The present invention relates to a machine and a method for packaging piece good combinations. Such machines and methods have been known for a long time from the prior art. Thus for example it is known that piece good combinations, for example containers, are wrapped by means of a plastic film which is then shrunk onto the containers. In addition it is also known from the prior art that a piece good combination is wrapped with a plastic film. The present invention relates in particular to such applications. Such wrapped packs usually have the disadvantage that any imprints can only be located on the containers themselves and therefore the possibility for example of additional advertising is extremely limited.

Therefore the object of the present invention is to create a possible means for providing such piece good combinations with further elements, for example with advertising. This object is achieved according to the invention by the subject matter of the independent claims. Advantageous embodiments and further modifications form the subject matter of the subordinate claims.

A machine according to the invention for packaging piece good combinations has a transport device which transports a plurality of piece goods in a predetermined transport direction, as well as a first wrapping device which is suitable and intended to wrap the piece goods with a film element, wherein this first wrapping device has a dispensing unit with a dispensing element revolving around the piece goods and/or a dispensing unit revolving around the piece goods, wherein the piece goods can be delivered to the first wrapping device in order to be wrapped by the film element. Furthermore the machine has at least one separating device (and/or separation-promoting device) arranged downstream of the first wrapping device in the transport direction of the piece goods, which separates portions of the stream of piece goods wrapped with the first film element from one another and/or promotes and/or simplifies a corresponding separation.

According to the invention the machine has a decorating device which adds at least one additional element to the piece good combinations and/or to the portions separated therefrom and/or to the piece goods and/or which provides the piece good combinations and/or the portions separated therefrom with at least one decoration.

Therefore within the context of the invention it is proposed that a marking and/or a further element is added to the piece good combinations. This further element can be for example an additional advertising item, such as for instance an advertising insert. Moreover, this additional element or this marking can also be a direct print, a banderole, a stamped print and the like.

In this case the piece goods are understood as the individual piece goods such as containers. Piece good combinations are understood to be in particular the prepared pack, that is to say in particular a pack wrapped by at least one film. The stream of piece goods is understood to be in particular the intermediate product produced during manufacture, that is to say the continuous plurality of piece goods which are advantageously already wrapped by at least one wrapping element and are in particular moving in the transport direction. Thus from this stream of piece goods the separating device advantageously produces the individual piece good combinations (or optionally also piece good groupings as intermediate products which can still be further processed).

In a further preferred embodiment the said separating device is suitable and intended to move at least in part synchronously or to be synchronised with the piece good combination. In this case this movement can in particular also take place synchronously.

The said separating device or at least one separating element of this separating device preferably moves in a direction which is perpendicular to the transport direction of the piece good combination, for example in order thus to cut the film element. Thus for example the separating element can be a cutting blade which is suitable and intended to be guided between individual containers and in this case to cut the film element. Furthermore, however, it would also be possible that the separating element does not directly carry out the separation of the piece good combination or of portions thereof, but merely facilitates this.

Thus the separating device can for example also have a perforation device as separating element which applies perforations or holes in the said film. In a subsequent module a portion of the piece good combination can for example be more or less torn off from another portion of the piece good combination, wherein the location with the perforations constitutes a predefined breaking point. The separating device (or the separating element thereof) preferably acts on the film element, in particular mechanically, and cuts or separates this at least locally.

In a further advantageous embodiment the wrapping device has a rigid carrier onto which the piece good combinations can be pushed. Thus for example the transport device can have a first conveyor belt which pushes the piece good combinations onto this rigid or stationary carrier. In addition the machine can also have lateral guiding elements which laterally stabilise the piece good combination in particular during the wrapping.

In this case it is possible that the first wrapping device also wraps this stationary base carrier and/or the lateral guiding elements. In a further process step the piece good combination wrapped in this way can be removed again from the carrier and/or the lateral guiding elements. The said transport direction is advantageously rectilinear. The transport device can be for example a conveyor belt, a transport chain or the like. In a further preferred embodiment it is possible that the decorating element or the additional element is adapted individually to the respective containers. Thus for example different advertisements can be added to different container combinations. Preferably, also a corresponding decoration, such as for instance a print, can be adapted individually to the containers or the container combinations.

Furthermore, the additional element can also be wrapped. In this case it is possible that an additional element is added above, beside or below the containers. Furthermore, it is conceivable that the additional element itself is flexible, for example made of paper or paperboard. In addition, however, the additional element itself can also have a certain rigidity in order thus to achieve a higher stability of the piece goods wrapped with the film element. In addition, it would also be possible that several additional elements are added, for example several different advertising items and/or support elements. In addition, not only an additional element can be delivered but also an imprint can be applied to the respective container combinations.

In a further advantageous embodiment the decorating device has a delivery device which delivers a plurality of additional elements individually to the piece goods. In this case it is for example possible that a clocked or clock-driven introduction of additional elements, for example advertising items, takes place. These can already be delivered for example before the container combination is wrapped with the first film element. In addition, it would also be possible that such additional elements are delivered after the wrapping with a first film element, but before the wrapping with a film element. For this purpose, for example, a robot device can be provided which removes the additional elements from a reservoir and then delivers piece goods, in particular individually.

In a further advantageous embodiment the decorating device could be a delivery device which adds a continuous additional element to the piece goods. Thus for example before the first wrapping or also before the second wrapping a strip-like additional element could be delivered, which is for example printed at regular intervals with advertising and/or which serves as an additional stabilisation element. During subsequent detachment of individual portions this continuous additional element can also be cut. In addition, however, as stated, an individual delivery would also be conceivable. In addition, the additional element could also be a label which is applied for example to piece goods already wrapped with the first film element or is applied to the piece goods themselves.

In a further advantageous embodiment the separating device is suitable and intended to detach piece good groupings or piece good combinations in variable grouping sizes. Thus for example piece good combinations consisting of 2×2 or 2×3 containers etc. could be detached. Thus a control device can cause the respectively required piece good combinations to be detached. In this case it would be possible that in a specific operating period exclusively specific container groupings, for instance 2×2 containers, are produced. Alternating sizes could also be produced, for example alternately a 2×2 pack and a 2×3 pack.

For this purpose the machine particularly preferably has a control device which moves or guides the separating element or the separating device appropriately. In an advantageous embodiment the decorating device delivers the respective decorations to the piece good groupings or the piece good combinations (or generally to the stream of piece goods) taking into consideration a respective size of the piece good combinations to be decorated, and/or delivers the additional element taking into consideration the respective size of the piece good combination to be decorated. In this way individual packs can be provided with corresponding also individually adapted advertisements.

In a further advantageous embodiment the machine has a sensor device which detects at least one parameter relevant for a detached piece good combination and in particular a size of this piece good combination. Thus for example after the separating element such a detection device can be provided, which is suitable and intended to detect in each case the sizes of the piece good combinations which have been detached. In this case these parameters can be communicated to a control device.

The sensor device is preferably suitable and intended to detect the said parameters contactlessly and in particular optically. Thus the sensor device could for example have a camera which records images of the individual piece good combinations so that a corresponding evaluation is possible. In addition, the sensor device could also for instance have one or more light barriers by which the starts and ends of the individual piece good combinations which are already detached can be detected, and thus (in particular also having regard to the transport speed of the piece good combination) a conclusion can be drawn as to the size of the pack and in particular the extent thereof in the transport direction. However, mechanically operating sensor devices would also be conceivable, which scan the piece good combinations and thus can determine the size thereof or the extension thereof in the transport direction.

However, it would also be conceivable that no detection device is provided, but in each case the pack size to be produced is predetermined by the control device and this size is also communicated to the decorating device, for example a printing unit. Thus for example a control device could predetermine that the next pack to be detached should be a 3×2 pack and the printing device could adapt correspondingly hereto.

In a further advantageous embodiment the transport device has at least one advancing device which pushes the piece goods into a working region of at least one of the wrapping devices. In this way—as mentioned above—the piece good combination can be pushed into the wrapping device and can be wrapped there with the film element. In addition, a transport unit could also be provided which removes the piece good combination wrapped with the film element from a wrapping device and/or from the carrier which is included in the wrapping.

The film element preferably has a thickness between 4 μm and 30 μm, preferably between 8 μm and 20 μm, preferably between 8 μm and 12 μm.

In a further advantageous embodiment the device has a second wrapping device which in an operating mode of the machine can be operated, at least at times, simultaneously with the first wrapping device. In this embodiment it is proposed that the piece good combination is wrapped a number of times and in particular first of all by a first film element and subsequently by a second film element. In this case it is conceivable that the wrapping directions of the two wrapping devices are opposed, in order in this way to increase the stability of the completely wrapped pack. Furthermore, it would be possible that the decorating device referred to here is arranged between these two wrapping devices.

In a further advantageous embodiment the decorating device is arranged before at least one wrapping device in the transport direction of the piece goods. In a further preferred embodiment the decorating device is arranged after the separating element in the transport direction of the piece goods. Thus for example it is possible to decide the point in the production at which the corresponding decoration or the additional element should be applied or delivered.

In principle in this case several procedures are conceivable. If for example an additional element is added, it is conceivable that first of all the piece good combination is wrapped with a first film element and then the additional element is added. It would also be conceivable that the additional element is added and then the two wrapping devices wrap the piece good combination. In a further advantageous embodiment the additional element can also be a self-adhesive element, for example a self-adhesive film, which is applied to the piece good combination.

In a further advantageous embodiment the decorating device is a printing device which provides the piece good combination or the piece good grouping with an imprint, and/or a labelling device which provides the piece good combinations and/or piece good groupings with labels. This printing device is advantageously a direct printing device. This printing device is preferably arranged above the transport path or the transport direction of the piece goods in order in particular to apply the print from above. Furthermore, it would also be conceivable that the machine has a drying device in order to dry a deposited print. In addition it would also be conceivable that the print is applied between a first wrapping device and a second wrapping device.

With direct printing it is possible to produce markings by contacting or contactless application of colours and/or dyes without mechanical alteration of the workpiece surface. Printing both with very high contrast and also a very high quality is made possible by colours which can be chosen freely. Prints with individual contents can also preferably be produced. An ink jet printing device is preferably used as the printing device. This printing device which preferably operates contactlessly is characterised in that individual ink drops or a jet composed of individual drops is conveyed at high speed onto the print surface.

Furthermore, the present invention is directed to a method for packaging piece good combinations, wherein a transport device transports a plurality of piece goods in a predetermined transport direction, and wherein a first wrapping device wraps the piece goods with a film element, wherein this first wrapping device has a dispensing unit revolving around the piece goods (in particular with a dispensing element revolving around the piece goods), wherein the piece goods are delivered to the first wrapping device in order to be wrapped by the first film element, and wherein with at least one separating device arranged downstream of the first wrapping device in the transport direction of the piece goods, portions of the stream of piece goods wrapped with the first film element are separated from one another or, as described above, promotes such a separation.

According to the invention the machine has a decorating device which adds an additional element to the piece good combinations and/or these portions and/or which provides the piece good groupings and/or piece good combinations or portions thereof with at least one decoration. This decoration is preferably a print and in particular a direct print. The additional element can be for instance an advertising item or a stabilising element.

In a preferred method at least one of these additional elements and/or a decoration is wrapped by at least one film element. In this way a better protection of this decoration or of the additional element can be achieved. In a further preferred method the size of the piece good combinations or of the separated distances of the piece good combinations is varied. The decoration can advantageously also be adapted according to this size and/or also the said additional element.

Further advantages and embodiments are apparent from the appended drawings.

In the drawings:

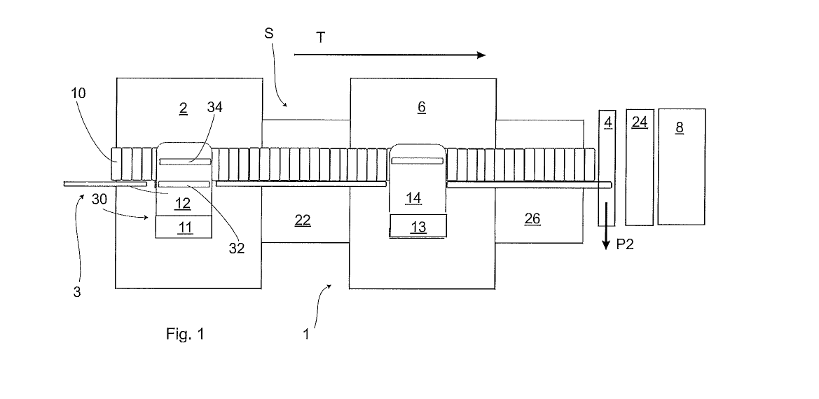

FIG. 1 shows a machine according to the invention with a decorating device in the form of a printing unit;

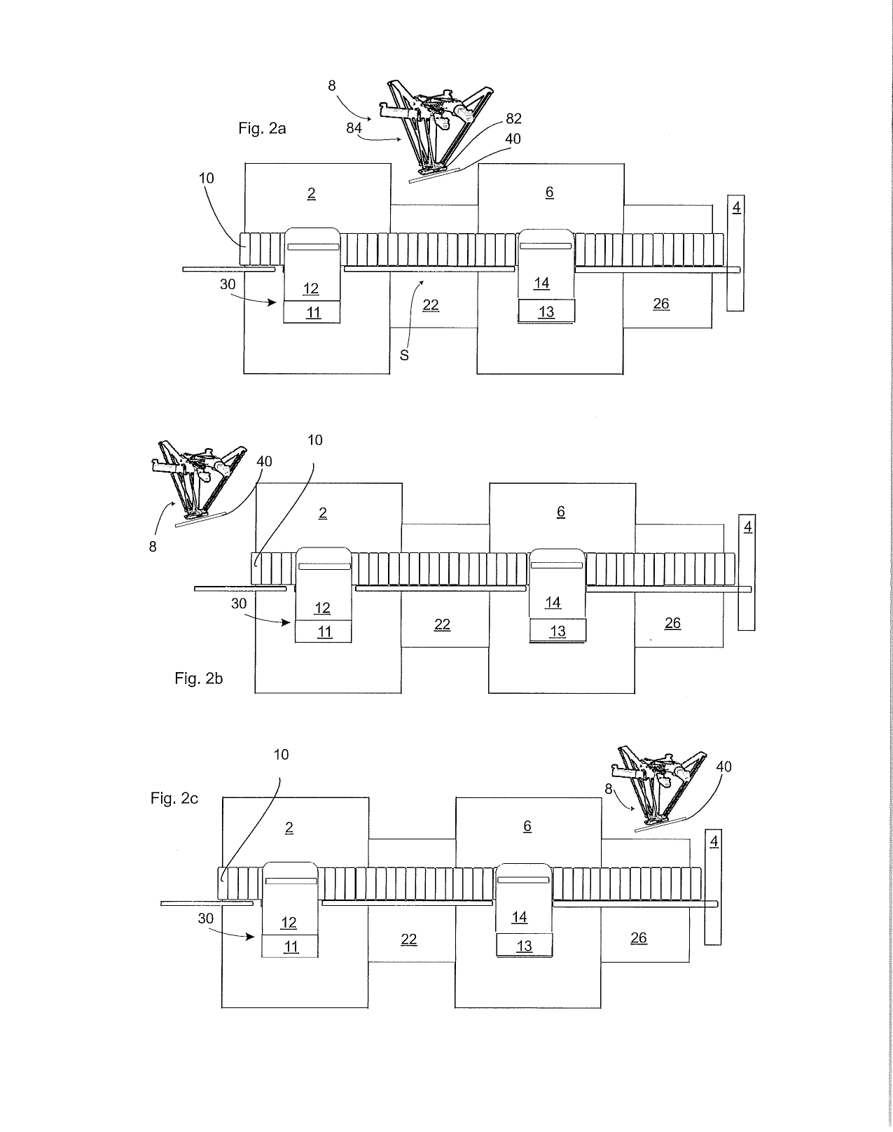

FIGS. 2a-2c show a machine according to the invention with a decorating device in the form of a delivery unit which can deliver additional elements individually;

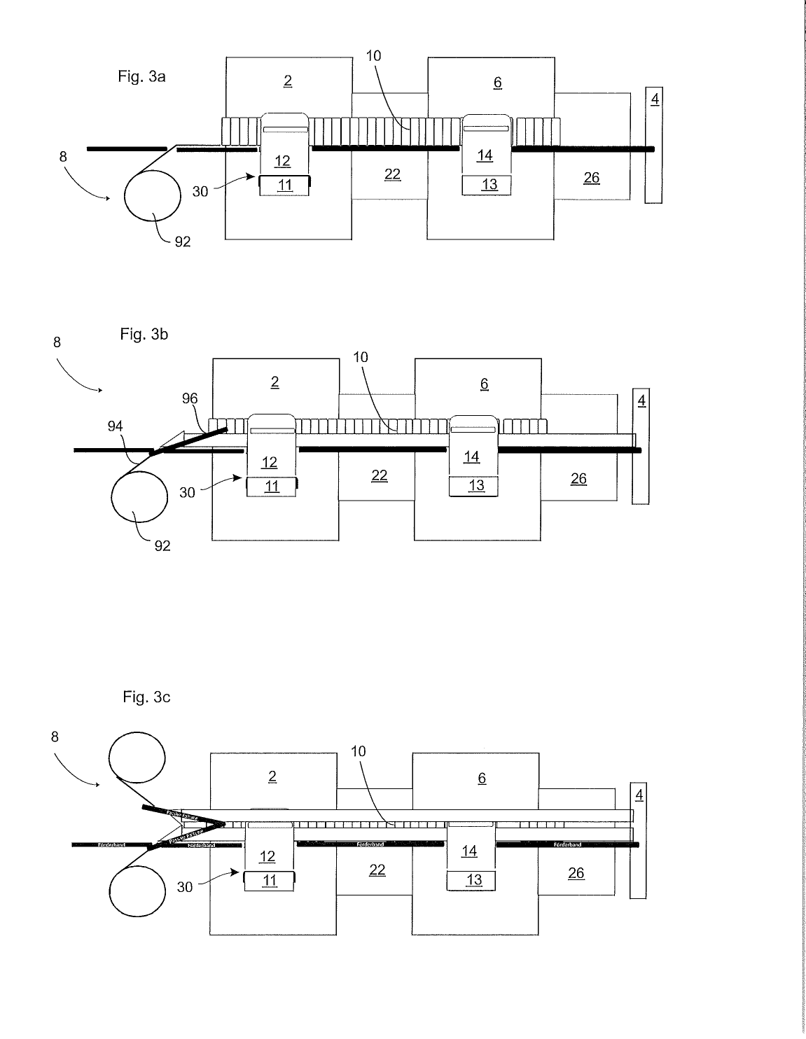

FIGS. 3a-3c show an embodiment of the invention, wherein a continuous additional element can be delivered;

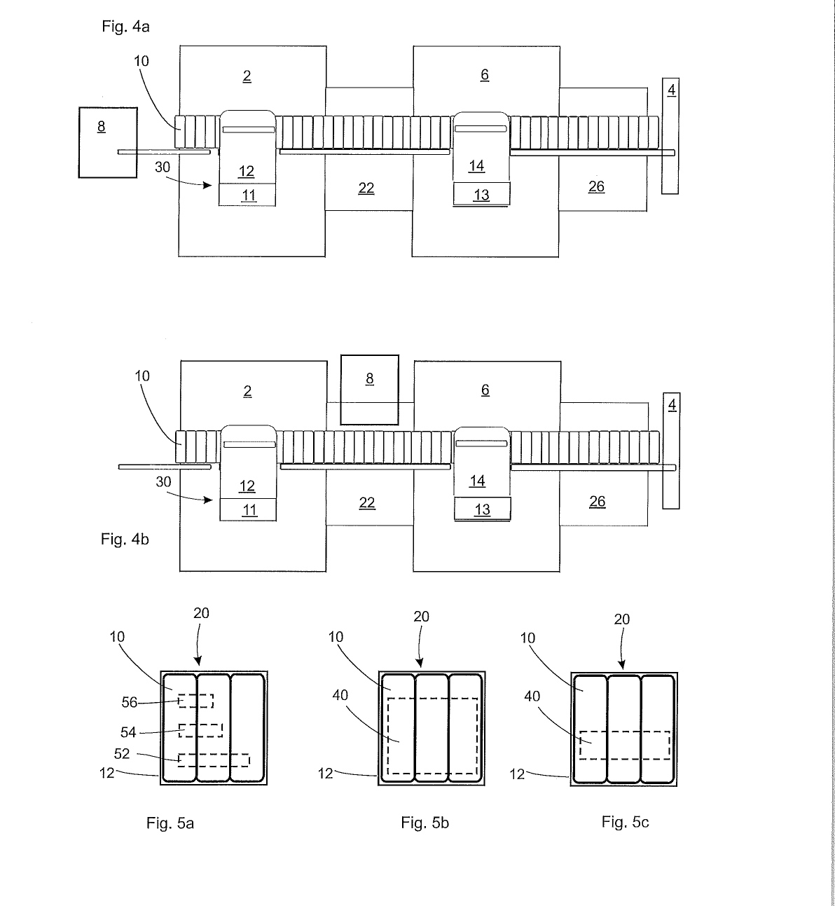

FIGS. 4a, 4b show a further embodiment according to the invention in which labelling takes place as the decoration; and

FIGS. 5a-5c show three possible representations of piece good combinations provided with an additional element.

FIG. 1 shows a first embodiment of a machine 1 according to the invention. In this embodiment an individualised printing of packages is possible. In this case the reference numeral 2 relates to a first wrapping device by which piece goods 10 delivered by a transport device 3 in a transport direction T are wrapped with a first film element 12. In this case the reference numeral 11 designates a film roll which revolves around the stream of piece goods or, here, the containers 10 in a plane which is perpendicular to the drawing. In this case a roll support (not shown) can be provided, on which a film roll 11 is rotatably arranged. The reference numeral S designates the stream of piece goods 10.

The reference numeral 22 designates a further transport unit of the transport device designated overall by 3, which in this case removes the wrapped containers from the first wrapping device 2. The reference numeral 34 designates a lateral guiding device which laterally guides the stream of containers. In addition, a likewise stationary carrier 32 can be provided, on which the containers are located during wrapping. This stationary carrier is likewise wrapped by the film element 12.

The reference numeral 6 designates a second wrapping device, which here is designed substantially corresponding to the first wrapping device 2. This also again has a film roll 13 as well as a second film element 14 with which the piece goods are wrapped. Advantageously, however, the two wrapping devices 2 and 6 wrap the piece goods in opposite revolving directions. Within the context of the invention, however, it is pointed out that here too on the second wrapping device could be omitted. The film roll 13 can be rotatably mounted on a roll carrier (not shown).

A further transport unit 26 which removes the piece goods from the second wrapping device is again likewise located downstream of the second wrapping device.

The reference numeral 4 designates a separating unit or a cutting unit, which cuts the continuously produced and wrapped piece good combinations in a defined manner. For this purpose this separating unit can have a separating element which can be guided with the container groupings along the transport direction T and so can make a cut along the arrow P2, i.e. in the vertical direction. However, other movements of the cutting element would also be possible, for example in a direction extending perpendicularly to the drawing plane.

The reference numeral 8 designates a decorating device, wherein in the embodiment shown in FIG. 1 this decorating device is a printing unit which applies imprints to the piece good combinations (not shown) which are now already detached.

In this case the separating element or cutting element of the separating unit 4 is capable of detaching piece good combinations of different sizes from the stream of piece goods. These can be provided with individual imprints by means of the printing device 8. The reference numeral 24 designates a sensor device or detection device which in each case for example detects the size of detached piece good combinations. In reaction to such a size the decorating device 8 can also be correspondingly controlled in order to apply corresponding prints (and in particular the sizes thereof) to the piece good combinations. In this connection it is pointed out that with the machine shown in FIG. 1 an individual printing of each single piece good combination is possible.

In a further advantageous embodiment the decorating device 8 can also have a printing element, such as a print head, which at least at times moves with the containers. In addition, printing elements can be provided which move both in the transport direction and also for example perpendicular thereto, in order to apply a print.

FIG. 2a shows a further embodiment of the present invention. The basic construction of the two wrapping devices and the transport units 22 and 24 arranged between them corresponds to that shown in FIG. 1 and therefore is not explained more precisely. In this case FIGS. 2a-2c show a clock-driven or clocked introduction of additional elements 40. These additional elements 40 can be for example advertising items or the like. The decorating device 8 here can be a device which has a receiving element 82 to accommodate the additional elements.

In this case this receiving element 82 can be for example a suction head which can remove individual additional elements for instance from a store (not shown). In addition, the receiving element could also have a gripping element which serves for gripping the additional elements. In addition, this decorating device 8 has a moving device 84, which enables substantially free movement in space of the receiving device 8. In the embodiment illustrated here this moving device can be a so-called tripod system. However, the receiving device 82 is preferably movable substantially freely in space in a specific circle or radius of movement.

In this case for control of this movement moving devices are provided which enable a movement in three directions perpendicular to one another. The driving devices can be for example electric motors, in particular linear motors, but also pneumatic or hydraulic drives.

In the embodiment illustrated in FIG. 2a the additional element is introduced after the first wrapping module or the first wrapping device 2 and before the second wrapping device 6. In this way it is possible that the introduced advertising is protected by the second film element 14, which is only applied subsequently.

In the embodiment illustrated in FIG. 2b the advertisement is also inserted before the first wrapping device 2. In the embodiment illustrated in FIG. 2c the additional element is inserted after the second wrapping device 6. In this case it would be conceivable for instance that the additional element is adhered from the exterior onto the second film element. It is pointed out that the invention described here can also operate with only one wrapping device, wherein here the additional element 40 can then be inserted before or also after this one wrapping device.

This additional element can be for example advertising which is printed on the actual element, for example a paper, cardboard or film element. The decorating device 8, which here can be a robot, can operate from a store. Advantageously, however, the additional elements are inserted before the separating device 4. The insertion of the additional elements can be carried out in different ways, for example by mere insertion, application, pre-fixing, simple adhesion or also by the use of different adhesive forces. Optionally, spraying with water can also already be sufficient in order to arrange the additional element securely on for example the first film element.

As also already explained with reference to FIG. 1, additional elements of different sizes can also be inserted. In particular this can be made dependent upon how large the piece good combinations to be detached later are or should be. Furthermore, it is also possible that the decorating device 8 predetermines the later pack sizes and/or also the location at which the additional element is placed inside the piece good combination. Furthermore—as mentioned above—the additional element can also be a stabilisation element, for instance a tray or the like. However, in the embodiments shown in FIGS. 2a and 2b the additional element is protected by at least one wrapping element. At the same time the additional element is visible through this (usually transparent) wrapping element.

FIGS. 3a -3c illustrate a continuous introduction of additional elements, for example advertising. In FIG. 3a a roll element 92 is illustrated, from which advertising is delivered to the containers, for example introduced below the containers. Cutting of these continuously delivered additional elements can already take place here before the wrapping with the first wrapping device, but it would also be possible that first of all the additional elements are delivered as a strip and then the entire product, i.e. both the film element and also the additional element, is cut by the separating device 4.

In the embodiment illustrated in FIG. 3b a continuous element 94 is likewise delivered, wherein however this can already have a fold. With this fold this additional element 94 can be folded and can be delivered in this folded state 96. Here too the cutting again takes place with the separating device 4. By this procedure the product can also already have fold lines when it is removed from the roll 92. In this way overall the stability of the piece good combinations thus produced can be increased. However, instead of the embodiment illustrated in FIG. 3b, here too the film element could also be introduced from above, i.e. in particular from above the containers 10. Such a procedure is illustrated in FIG. 3c. In FIG. 3c several film elements are even delivered from above as well as from below.

FIGS. 4a and 4b illustrate a further procedure for introduction of an additional element. The additional element here is a label (not shown), which can be applied in addition to the film element 12 and/or 14.

In the embodiment shown in FIG. 4a such a label is adhered to the containers before they are wrapped by the first wrapping device 2. In this case it would be possible that a label is adhered individually on each container, but also a label could be adhered on several containers or beyond several containers (wherein this label is then preferably also cut by the separating device).

In the embodiment illustrated in FIG. 4b this labelling takes place between the first wrapping device 2 and the second wrapping device 6. Therefore in this embodiment the labels are applied to the first film element 12 which already wraps the containers 10. It would also be conceivable here to deliver the labels after the second wrapping device. Labels or generally additional elements could also be delivered at several locations. These additional elements are preferably self-adhesive labels, i.e. labels which already have an adhesive coating.

The drawings 5a-5c show three examples of piece good combinations 20 with additional elements. In the illustration in FIG. 5a a print is arranged on the elements, such as for example an advertising print 56, a barcode 54 or even a combination of digits, such as for instance a best before date 52. In the embodiment illustrated in FIG. 5b an additional element 40 of large surface area is arranged on the containers 10 and is wrapped by the first film element 12. In this case this additional element 40 is visible through the film element 12.

In the embodiment illustrated in FIG. 5c an additional element 40 in the form of a strip is introduced. As mentioned above, these can be the most varied additional elements, such as for example a direct print, a banderole, a stamped print, advertising already applied to a film element and the like. Advantageously, however, the advertising is introduced in such a way that it is held by the packaging or the wrapping.

The applicant reserves the right to claim all the features disclosed in the application documents as essential to the invention in so far as they are individually or in combination novel over the prior art. Furthermore it is pointed out that features which may be advantageous per se have also been described in the individual drawings. The person skilled in the art recognises immediately that a specific feature described in a drawing may also be advantageous without the incorporation of further features from this drawing. Furthermore the person skilled in the art recognises that advantages may also result from a combination of several features shown in individual drawings or in different drawings.

### LIST OF REFERENCES

1 machine
2 first wrapping device
3 transport device
4 separating device
6 second wrapping device
8 decorating device/receiving device/printing device
10 piece goods
11 film roll
12 film element
13 film roll carrier
14 second film element
20 piece good combination
22 further transport unit
24 sensor device/detecting device
26 transport unit
30 dispensing unit
32 stationary carrier
34 lateral guiding device
40 additional elements
52 best before date
54 barcode
56 advertising print
82 receiving element
84 moving device
92 roll
94 continuous element/additional element
96 folded additional element
P arrow, direction of movement of the separating element of the separating device
T transport direction
S stream of piece goods

1. Machine for packaging piece good combinations with a transport device which transports a plurality of piece goods in a predetermined transport direction, with a first wrapping device which is suitable and intended for wrapping the piece goods with a film element, wherein this first wrapping device has a dispensing unit revolving around the piece goods, wherein the piece goods can be delivered to the first wrapping device in order be wrapped by the film element, and with at least one separating device arranged downstream of the first wrapping device in the transport direction of the piece goods, which separates portions of the stream of piece goods wrapped with the first film element from one another and/or promotes a separating process, characterised in that the machine has a decorating device which provides the piece goods with at least one decoration.

2. Machine according to claim 1, wherein the decorating device is a printing device which provides the piece good groupings or the piece good combinations with an imprint, and/or a labelling device which provides the piece good groupings or the piece good combinations with labels.

3. Machine according to claim 1, wherein the separating device is suitable and intended to detach piece good groupings or piece good combinations in variable grouping sizes.

4. Machine according to claim 1, wherein the decorating device applies the respective decorations to the piece good groupings or piece good combinations taking into consideration a respective size of the piece good combinations to be decorated.

5. Machine according to claim 1, wherein the machine has a sensor device which detects at least one parameter relevant for a separate piece good grouping or piece good combination and in particular detects a size of this piece good grouping or piece good combination.

6. Machine according to claim 1, wherein the transport device has an advancing device which pushes the piece goods into a working region of at least one of the wrapping devices.

7. Machine according to claim 1, wherein the machine has a second wrapping device which in an operating mode of the machine can be operated, at least at times, simultaneously with the first wrapping device.

8. Machine according to claim 1, wherein the decorating device is arranged in the transport direction of the piece goods after the separating device.

9. Method for packaging piece good combinations, wherein a transport device transports a plurality of piece goods in a predetermined transport direction, and wherein a first wrapping device wraps the piece goods with a film element, wherein this first wrapping device has a dispensing unit revolving around the piece goods, wherein the piece goods are delivered to the first wrapping device in order be wrapped by the film element, and wherein with at least one cutting device arranged downstream of the first wrapping device in the transport direction of the piece goods, portions of the stream of piece goods wrapped with the first film element are separated from one another, wherein the machine has a decorating device which provides the piece goods with at least one decoration.

10. Method according to claim 9, wherein a size of the piece good groupings is varied.
